(19) United States
(12) Patent Application Publication
(10) Pub. No.: US 2022/0333810 A1
(43) Pub. Date: Oct. 20, 2022

(54) MODEL SHARING SYSTEM, MODEL MANAGEMENT APPARATUS, AND CONTROL APPARATUS FOR AIR CONDITIONING APPARATUS

(71) Applicant: Mitsubishi Electric Corporation, TOKYO (JP)

(72) Inventor: Kento NISHITSUJI, TOKYO (JP)

(21) Appl. No.: 17/760,851

(22) PCT Filed: Dec. 13, 2019
(86) PCT No.: PCT/JP2019/048993

§ 371 Date: Mar. 16, 2022

(51) Int. Cl. F24F 11/63; G05B 19/042

(52) U.S. Cl. CPC F24F 11/63; G05B 19/042; F24F 2140/00

(57) ABSTRACT

A model sharing system includes: a plurality of control apparatuses that each control a corresponding one of apparatuses to be controlled; and a model management apparatus that stores a learned model correspondingly to an operating status of the apparatus to be controlled. The control apparatus-obtains, from the model management apparatus, a learned model corresponding to an operating status identical to or similar to the operating status of a corresponding one of the apparatuses to be controlled and then controls the corresponding apparatus using the obtained learned model. The operating status includes at least one of the following: type of the apparatus to be controlled; an environment where the apparatus to be controlled is installed; or setting content of the apparatus to be controlled.

### CROSS REFERENCE TO RELATED APPLICATION

This application is a U.S. National Stage Application of International Patent Application No. PCT/JP2019/048993, filed on Dec. 13, 2019, the disclosure of which is incorporated herein by reference.

### TECHNICAL FIELD

This disclosure relates to a model sharing system, a model management apparatus, and a control apparatus for air conditioning apparatus.

### BACKGROUND

Some known methods pursue higher degrees of accuracy for control by using machine learning. Such methods generate models based on control programs and control parameters through learning of the past operating records.

PTL 1 describes a control apparatus for a plurality of robots that seeks to reduce learning time by sharing the learned models.

### PATENT LITERATURE

PTL 1: Japanese Patent Laying-Open No. 2017-30135

In case the same learned model is shared by two or more control apparatuses used to control different apparatuses, the content of control may largely differ from one apparatus to another depending on operating statuses of the apparatuses to be controlled. This may result in a poor accuracy of control.

Taking for instance, an air conditioning apparatus, how soon the room can be cooled or warmed may heavily depend on such factors as configurations of the apparatus and materials used in and surrounding climate of a property where the air conditioning device is installed. Thus, high accuracy control may be difficult to achieve with the methods in which the same model is shared by control apparatuses for air conditioning apparatuses.

### SUMMARY

To this end, this disclosure is directed to providing a model sharing system, a model management apparatus and a control system for control of air conditioning apparatuses that enable high accuracy control in case the content of control largely differs from one apparatus to another depending on operating statuses of the apparatuses to be controlled.

A model sharing system disclosed herein includes: a plurality of control apparatuses that each control a corresponding one of apparatuses to be controlled; and a model management apparatus that stores a learned model correspondingly to an operating status of each of the apparatuses to be controlled. The control apparatuses each obtain, from the model management apparatus, a learned model corresponding to an operating status identical to or similar to the operating status of a corresponding one of the apparatuses to be controlled and then control the corresponding apparatus using the obtained learned model. The operating status includes at least one of the following: type of the apparatus to be controlled; an environment where the apparatus to be controlled is installed; or setting content of the apparatus to be controlled.

The model management apparatus disclosed herein is for a model sharing system that allows control apparatuses for a plurality of air conditioning apparatuses to share a plurality of learned thermal load models. The model management apparatus includes: a model storage memory that stores therein the learned thermal load models correspondingly to operating statuses of the air conditioning apparatuses; a communicator allowed to communicate with the control apparatuses for the air conditioning apparatuses; a model provider that provides the control apparatus for the air conditioning apparatus with, of the plurality of learned thermal load models stored in the model storage memory, a thermal load model corresponding to an operating status identical to or having a highest degree of similarity to the operating status of the air conditioning apparatus in response to a request for transmission of the thermal load model designating the operating status of the air conditioning apparatus from the control apparatus for the air conditioning apparatus; and a model registering memory that obtains the learned thermal load model designating the operating status of the air conditioning apparatus from the air conditioning apparatus and that prompts the model storage memory to store therein the learned thermal load model thus obtained correspondingly to the operating status of the air conditioning apparatus.

The control apparatus for the air conditioning apparatus disclosed herein includes a communicator allowed to communicate with the model management apparatus in charge of managing the learned thermal load models sharable by the control apparatuses for the air conditioning apparatuses. In the model management apparatus is storable the learned thermal load model correspondingly to the operating status of the air conditioning apparatus. The control apparatus for the air conditioning apparatus disclosed herein further includes a controller that issues a request for transmission of the thermal load model designating the operating status of the air conditioning apparatus and that obtains the learned thermal load model transmitted from the model management apparatus in response to the request for transmission. The learned thermal load model corresponds to an operating status identical to or having a highest degree of similarity to the designated operating status.

The control apparatus for the air conditioning apparatus disclosed herein further includes a learner that, by operating the air conditioning apparatus, obtains teaching data and input data of the thermal load model for additional learning and that carries out additional learning of the obtained thermal load model using the input data and the teaching data thus obtained. The controller controls the air conditioning apparatus using the thermal load model that has been additionally learned. The communicator transmits, to the model management apparatus, the thermal load model that has been additionally learned and the operating status of the air conditioning apparatus. The operating status includes at least one of the following: type of the air conditioning apparatus, an environment where the air conditioning apparatus is installed, or setting content of the air conditioning apparatus.

The control apparatuses each obtain, from the model management apparatus, a learned model corresponding to an operating status identical to or similar to the operating status of a corresponding one of the apparatuses to be controlled and then control the corresponding one of the apparatuses to be controlled using the obtained learned model. Thus, high accuracy control may be successfully achieved in case, for example, the content of control largely differs from one apparatus to another depending on operating statuses of apparatuses to be controlled.

### BRIEF DESCRIPTION OF DRAWINGS

FIG. 1 is a block diagram that illustrates an overall structure of a model sharing system 1 according to a first embodiment of this disclosure.

FIG. 2 is a table that illustrates exemplified pieces of information stored in a model storage unit 101.

FIG. 3 is a diagram that illustrates an exemplified configuration of an air conditioning apparatus.

FIG. 4 is a block diagram that illustrates an exemplified control of an air conditioning apparatus 2a executed by a controller 112A.

FIG. 5 is a diagram that illustrates an exemplified thermal load model.

FIG. 6 is a table that illustrates an exemplified output data of the thermal load model.

FIG. 7 is a table that illustrates an exemplified output data of the thermal load model.

FIG. 8 is a table that illustrates an exemplified operating status.

FIG. 9 is a flow chart that illustrates processing steps when a control apparatus 11A that has just been activated obtains a thermal load model from a model management apparatus 10 according to a first embodiment of this disclosure.

FIG. 10 is a flow chart that illustrates processing steps when a control apparatus 11A carries out additional learning according to the first embodiment.

FIG. 11 is a drawing that illustrates hardware configurations of the model management apparatus 10 and of the control apparatuses 11A, 11B.

### DETAILED DESCRIPTION

A model sharing system according to embodiments of this disclosure is hereinafter described referring to the accompanying drawings. Any structural elements illustrated in the drawings with the same reference signs are identical or equivalent to each other, which applies to the entire text of embodiments described herein. In the drawings, relative sizes of the illustrated structural elements may differ from their real sizes. The structural elements in the entire text of this specification are only described and illustrated by way of example and are not necessarily configured as such. In some instances, all of the elements and devices described herein may not necessarily be indispensable. The combinations of the structural elements described herein are only illustrated by way of example. The structural elements may be suitably combined otherwise or may be applicable to the other embodiment(s). Any devices of the same type distinguishable with superscript or subscript notation may be illustrated without such notation or reference signs unless they should particularly be identified or distinguished.

### First Embodiment

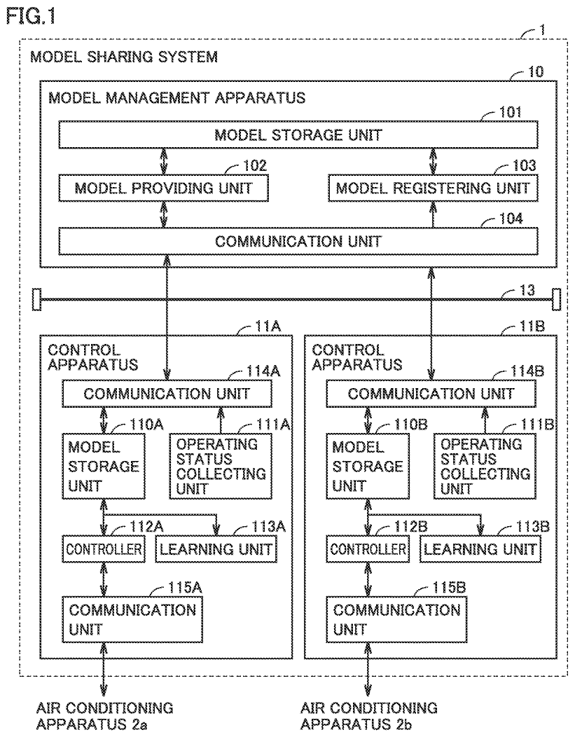

FIG. 1 is a block diagram that illustrates an overall structure of a model sharing system 1 according to a first embodiment of this disclosure.

In model sharing system 1, a control apparatus 11A and a control apparatus 11B of air conditioning apparatuses 2a and 2b are allowed to share a plurality of learned thermal load models.

Model sharing system 1 includes a model management apparatus 10 and control apparatuses 11A and 11B.

Model management apparatus 10 is connected to control apparatuses 11A and 11B through an electric communication line 13 in a manner that apparatus 10 is allowed to communicate with these control apparatuses. Model management apparatus 10 is allowed to transmit and receive thermal load models to and from control apparatuses 11A and 11B.

Model management apparatus 10 includes a communication unit 104, a model providing unit 102, a model registering unit 103, and a model storage unit 101.

Model storage unit 101 stores therein a learned thermal load model correspondingly to the operating status of the air conditioning apparatus.

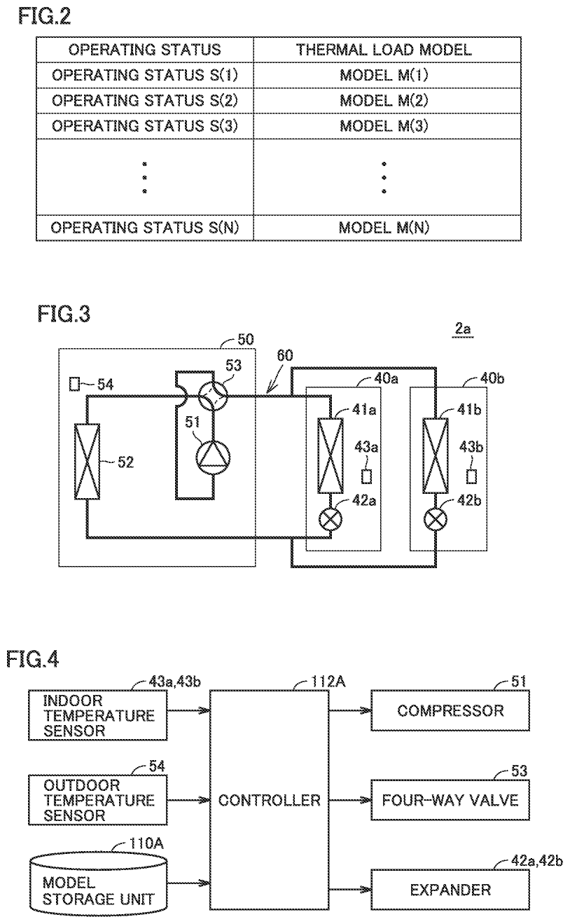

FIG. 2 is a table that illustrates exemplified pieces of information stored in model storage unit 101.

In model storage unit 101 are stored pieces of information that indicate thermal load models M(1) to M(N) correspondingly to operating statuses S(1) to S(N) of the air conditioning apparatuses. In case thermal load models M(1) to M(N) are models of a neural network, model storage unit 101 stores therein weighting factors of the neural network as information on thermal load models M(1) to M(N).

Communication unit 104 is allowed to communicate with control apparatuses 11A and 11B through electric communication line 13.

Model providing unit 102 receives a request for transmission of the thermal load model from either one of control apparatuses 11A and 11B for the air conditioning apparatuses.

When, for example, the request for transmission is transmitted by control apparatus 11A for the air conditioning apparatus, model providing unit 102 provides control apparatus 11A with, of the learned thermal load models stored in model storage unit 101, a thermal load model corresponding to an operating status identical to or having a highest degree of similarity to the operating status of air conditioning apparatus 2a. For example, model providing unit 102 normalizes values in the entries that indicate the operating status of air conditioning apparatus 2a and also normalizes values in the entries that indicate the operating status stored in model storage unit 101. Thus, model providing unit 102 normalizes two different operating statuses. Model providing unit 102, based on the Euclidean distance of the normalized two operating statuses, calculates a degree of similarity between the operating status of air conditioning apparatus 2a and the operating status stored in model storage unit 101.

When, for example, the request for transmission is transmitted by control apparatus 11B for the air conditioning apparatus, model providing unit 102 provides control apparatus 11B with, of the learned thermal load models stored in model storage unit 101, a thermal load model corresponding to an operating status identical to or having a highest degree of similarity to the operating status of air conditioning apparatus 2b. For example, model providing unit 102 normalizes values in the entries that indicate the operating status of air conditioning apparatus 2b and also normalizes values in the entries that indicate the operating status stored in model storage unit 101. Thus, model providing unit 102 normalizes two different operating statuses. Model providing unit 102, based on the Euclidean distance of the normalized two operating statuses, calculates a degree of similarity between the operating status of air conditioning apparatus 2b and the operating status stored in model storage unit 101.

The similarity calculating method described above is just an example. The degree of similarity may be calculated by any available method that uses the operating status for calculation. For instance, the normalized values may be weighted.

Model registering unit 103 obtains a set of the learned thermal load model and the operating status of the air conditioning apparatus transmitted from either one of control apparatuses 11A and 11B. Model registering unit 103 prompts model storage unit 101 to store therein the learned thermal load model obtained earlier correspondingly to the obtained operating status of the air conditioning apparatus.

Control apparatus 11A includes a communication unit 114A, a learning unit 113A, a model storage unit 110A, a controller 112A, and an operating status collecting unit 111A.

Communication unit 114A is allowed to communicate with model management apparatus 10 through electric communication line 13.

Model storage unit 110A stores therein the learned thermal load model obtained from model management apparatus 10 or an additionally learned, thermal load model obtained as a result of additional learning of the learned thermal load model obtained from model management apparatus 10.

Operating status collecting unit 111A collects pieces of information regarding the operating status of air conditioning apparatus 2a.

Controller 112A issues a request for transmission of a thermal load model designating the operating status of air conditioning apparatus 2a. Controller 112A obtains a learned thermal load model transmitted from model management apparatus 10 in response to the request for transmission of the thermal load model. Then, controller 112A prompts model storage unit 110A to store therein the learned thermal load model thus obtained. The learned thermal load model transmitted from model management apparatus 10 corresponds to an operating status identical to or having a highest degree of similarity to the operating status of air conditioning apparatus 2a contained in the request for transmission.

Learning unit 113A drives air conditioning apparatus 2a to operate and thereby obtains teaching data and input data of the thermal load model for additional learning. Learning unit 113A, using the obtained teaching data and input data, carries out additional learning of the thermal load model stored in model storage unit 110A.

Controller 112A controls air conditioning apparatus 2a using the thermal load model that has been additionally learned. Communication unit 115A performs communication of control commands from controller 112A to air conditioning apparatus 2a and communication of sensor data from air conditioning apparatus 2a to controller 112A.

Communication unit 114A transmits, to model management apparatus 10, the thermal load model that has been additionally learned and the operating status of air conditioning apparatus 2a.

Control apparatus 11B is configured similarly to control apparatus 11A and is thus not redundantly described herein.

FIG. 3 is a diagram that illustrates an exemplified configuration of air conditioning apparatus 2a.

Air conditioning apparatus 2a includes an outdoor unit 50 and indoor units 40a and 40b.

Outdoor unit 50 includes a compressor 51, a thermal source heat exchanger 52, and a four-way valve 53. Compressor 51 compresses and discharges a refrigerant. Thermal source heat exchanger 52 is for heat exchange between outdoor air and the refrigerant. Four-way valve 53 changes the flow direction of the refrigerant depending on the operation mode. Outdoor unit 50 includes an outdoor temperature sensor 54 that detects outdoor air temperatures.

Indoor unit 40a includes a load heat exchanger 41a and an expander 42a. Load heat exchanger 41a is for heat exchange between indoor air and the refrigerant. Expander 42a decompresses the refrigerant at high pressure and thereby expands the refrigerant. Indoor unit 40a includes an indoor temperature sensor 43a that detects room temperatures.

Indoor unit 40b includes a load heat exchanger 41b and an expander 42b. Load heat exchanger 41b is for heat exchange between indoor air and the refrigerant. Expander 42b decompresses the refrigerant at high pressure and thereby expands the refrigerant. Indoor unit 40b includes an indoor temperature sensor 43b that detects room temperatures.

Compressor 51 may be, for example, an inverter-controlled compressor with a variable capacity in response to changes of an operation frequency. Expanders 42a and 42b may be, for example, electronic expansion valves.

In outdoor unit 50 and indoor unit 40a, compressor 51, thermal source heat exchanger 52, expander 42a and load heat exchanger 41a are interconnected and thereby constitute a refrigerant circuit 60 in which the refrigerant is circulated. In outdoor unit 50 and indoor unit 40b, compressor 51, thermal source heat exchanger 52, expander 42b and load heat exchanger 41b are interconnected and thereby constitute a refrigerant circuit 60 in which the refrigerant is circulated.

Air conditioning apparatus 2b is configured similarly to air conditioning apparatus 2a and is thus not redundantly described herein.

FIG. 4 is a block diagram that illustrates an exemplified control of air conditioning apparatus 2a executed by controller 112A.

When indoor unit 40a is driven to operate, controller 112A controls the operation frequency of compressor 51 and the degree of opening of expander 42a based on an outdoor air temperature detected by outdoor temperature sensor 54, and a set temperature of and room temperature detected by indoor temperature sensor 43a. When indoor unit 40b is driven to operate, controller 112A controls the operation frequency of compressor 51 and the degree of opening of expander 42b based on an outdoor air temperature detected by outdoor temperature sensor 54, and a set temperature of and room temperature detected by indoor temperature sensor 43b.

When indoor units 40a and 40b are both driven to operate, controller 112A controls the operation frequency of compressor 51 and the degrees of opening of expanders 42a and 42b based on an outdoor air temperature detected by outdoor temperature sensor 54, a set temperature and room temperature of indoor unit 40a, and a set temperature and room temperature of indoor unit 40b.

Controller 112A changes the flow path of four-way valve 53 depending on the operation mode of the air conditioning apparatus; a cooling mode or a heating mode.

Controller 112A controls additional learning of the learned thermal load models stored in model storage unit 110A. During the operation, controller 112A controls air conditioning apparatus 2a using the learned thermal load models stored in model storage unit 110A.

The control of air conditioning apparatus 2b by controller 112B is similar to the control of air conditioning apparatus 2a by controller 112A and is thus not redundantly described herein.

Learning unit 113A generates the thermal load models through supervised learning using learning data. Learning unit 113A revises the thermal load models through supervised learning using additional learning data (additional learning). The supervised learning refers to learning of features and characteristics in a large number of sets of learning data containing inputs and results (labels) and furnished to the learning unit. Thus, results may be estimated from the inputs (generalization).

FIG. 5 is a diagram that illustrates an exemplified thermal load model.

As illustrated in FIG. 5, the thermal load model is configured as a neural network. The neural network includes an input layer consisting of neurons, an intermediate layer (hidden layer) consisting of neurons, and an output layer consisting of neurons. The neural network may have one or two or more intermediate layers. Input data X(i) is input to the i(th) unit of the input layer. Output data Z is output from the output layer.

Input data X(1) to X(N) are pieces of data that indicate factors affecting the thermal load of air conditioning apparatus 2. Output data Z is a piece of data that indicates the thermal load of air conditioning apparatus 2.

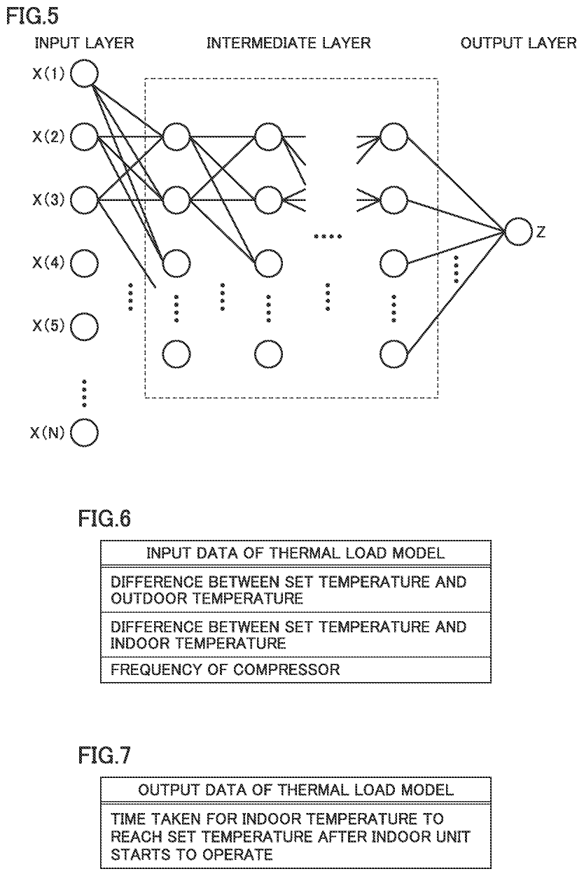

FIG. 6 is a table that illustrates an exemplified input data of the thermal load model.

As illustrated in FIG. 6, the input data of the thermal load model contains at least one of the following; a difference between the set temperature and outdoor air temperature, a difference between the set temperature and indoor air temperature, or the frequency of the compressor provided in air conditioning apparatus 2.

FIG. 7 is a table that illustrates an exemplified output data of the thermal load model.

As illustrated in FIG. 7, output data Z of the thermal load model is a length of time for the indoor temperature to reach the set temperature after indoor unit 40 starts to operate.

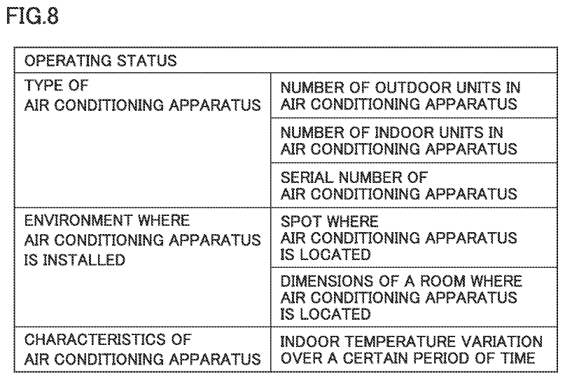

FIG. 8 is a table that illustrates an exemplified operating status.

The operating status includes at least one of the following; type of air conditioning apparatus 2, an environment where air conditioning apparatus 2 is installed, or setting content of air conditioning apparatus 2.

The type of air conditioning apparatus 2 includes at least one of the following; the number of outdoor units 50 of air conditioning apparatus 2, the number of indoor units 40 of air conditioning apparatus 2, or serial number of air conditioning apparatus 2.

The environment where air conditioning apparatus 2 is installed includes at least one of the following; a spot where air conditioning apparatus 2 is located or the size of a room where air conditioning apparatus 2 is located.

The setting content of air conditioning apparatus 2 includes an indoor temperature variation over a certain period of time while air conditioning apparatus 2 is being operated.

Controller 112A obtains the thermal load model from model management apparatus 10 based on the operating status of air conditioning apparatus 2a. Learning unit 113A carries out additional learning of the obtained thermal load model using learning data obtained during a test run.

During the operation of air conditioning apparatus 2a, controller 112A furnishes input data to the thermal load model that has been additionally learned and obtains output data of the thermal load model that has been additionally learned. The input data contains at least one of the following; a difference between the set temperature and outdoor temperature, a difference between the set temperature and indoor temperature, or the frequency of the compressor provided in the air conditioning apparatus. The output data is a length of time for the indoor temperature to reach the set temperature after indoor unit 40 starts to operate. For example, controller 112A decides, based on this output data, a schedule including the operation start time of air conditioning apparatus 2a.

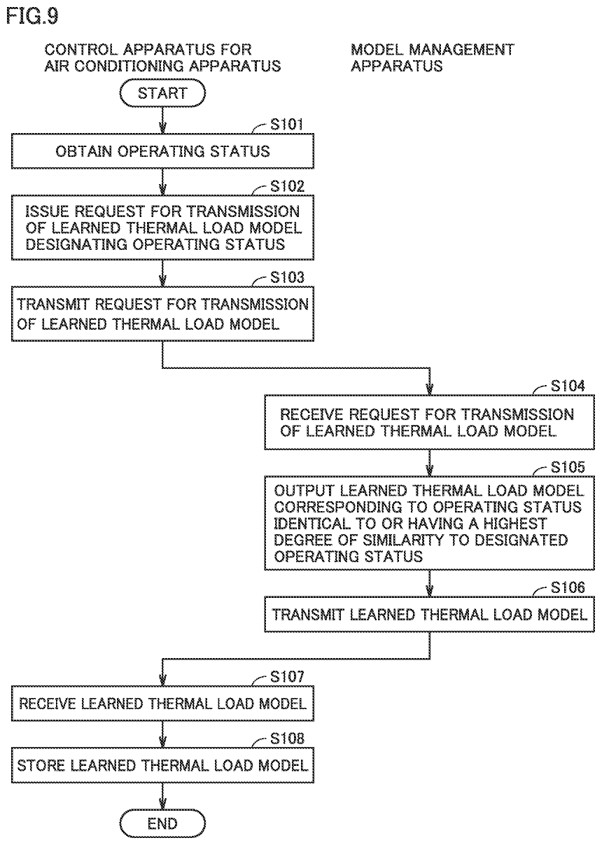

FIG. 9 is a flow chart that illustrates processing steps when control apparatus 11A that has just been activated obtains a thermal load model from model management apparatus 10 according to the first embodiment.

In step S101, operating status collecting unit 111A of control apparatus 11A obtains the operating status of air conditioning apparatus 2a. The control of air conditioning apparatus 2a is significantly affected by an indoor temperature variation over a certain period of time and the numbers of outdoor units 50 and of indoor units 40. Operating status collecting unit 111A, therefore, obtains these pieces of information.

An upper-limit value and a lower-limit value are set for values in the entries of the operating status. When the obtained values in the entries of the operating status of air conditioning apparatus 2a are greater than the upper-limit value, operating status collecting unit 111A reduces the values to the upper-limit value. When the obtained values in the entries of the operating status of air conditioning apparatus 2a are smaller than the lower-limit value, operating status collecting unit 111A increases the values to the lower-limit value.

In step S102, controller 112A of control apparatus 11A issues a request for transmission of the learned thermal load model designating the operating status obtained in step S101.

In step S103, communication unit 114A of control apparatus 11A transmits, to model management apparatus 10, a request for transmission of the learned thermal load model designating the operating status issued in step S102.

In step S104, communication unit 104 of model management apparatus 10 receives the request for transmission of the learned thermal load model designating the operating status.

In step S105, model providing unit 102 of model management apparatus 10 outputs, of the thermal load models stored in model storage unit 101, a learned thermal load model corresponding to an operating status identical to or having a highest degree of similarity to the designated operating status to communication unit 104.

In step S106, communication unit 104 of model management apparatus 10 transmits the learned thermal load model that has been output from model providing unit 102 to control apparatus 11A that transmitted the request for transmission.

In step S107, communication unit 114A of control apparatus 11A receives the learned thermal load model.

In step S108, controller 112A of control apparatus 11A prompts model storage unit 110A to store therein the learned thermal load model thus received.

The processing steps when control apparatus 11B that has just been activated obtains the thermal load model from model management apparatus 10 are similar to those illustrated in FIG. 9 and are thus not redundantly described herein.

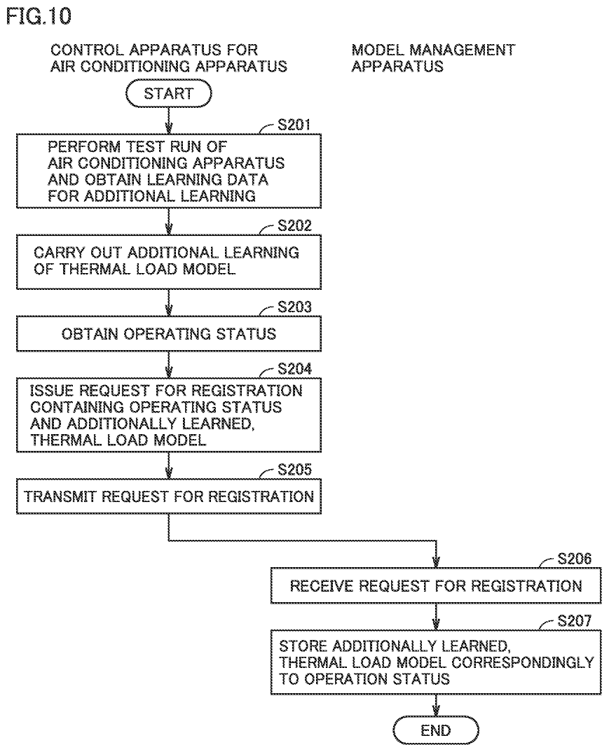

FIG. 10 is a flow chart that illustrates processing steps when control apparatus 11A according to the first embodiment carries out additional learning.

In step S201, controller 112A of control apparatus 11A carries out a test run of air conditioning apparatus 2a to obtain learning data for additional learning containing input data and teaching data.

In step S202, controller 112A of control apparatus 11A reads the thermal load model stored in model storage unit 110A. Controller 112A carries out additional learning of the obtained thermal load model using the obtained learning data for additional learning.

In step S203, operating status collecting unit 111A of control apparatus 11A obtains the operating status of air conditioning apparatus 2a. Operating status collecting unit 111A obtains pieces of information, for example, an indoor temperature variation over a certain period of time and the numbers of outdoor units 50 and of indoor units 40.

In step S204, controller 112A of control apparatus 11A issues a request for registration including the operating status obtained in step S203 and the additionally learned, thermal load model.

In step S205, communication unit 114A of control apparatus 11A transmits, to model management apparatus 10, the request for registration issued in step S204.

In step S206, communication unit 104 of model management apparatus 10 receives the request for registration including the operating status and the additionally learned, thermal load model.

In step S207, model registering unit 103 of model management apparatus 10 prompts model storage unit 101 to store therein the additionally learned, thermal load model included in the request for registration correspondingly to the operating status included in the request for registration.

Subsequent to step S205, the following steps are carried out by control apparatus 11A.

The processing steps for additional learning by control apparatus 11B are similar to the steps illustrated in FIG. 10 and are thus not redundantly described herein.

This disclosure is not necessarily limited to the embodiment described thus far. This disclosure may include the following modified embodiments.

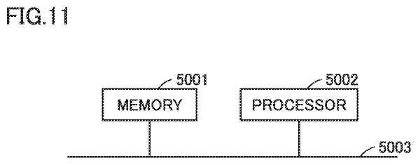

1] Model management apparatus 10 and control apparatuses 11A and 11B described in the embodiment above may be digital circuits configured as either hardware or software. In case the software is used to implement functions of model management apparatus 10 and of control apparatuses 11A and 11B, model management apparatus 10 and control apparatuses 11A and 11B may each include, for example, a processor 5002 and a memory 5001 that are interconnected through a bus 5003, as illustrated in FIG. 11. In this instance, programs stored in memory 5001 are executable by processor 5002. Processor 5002 may include, for example, a main processor and a processor for use in communication. Memory 5001 may include, for example, a RAM, flash memory or hard disc.

2] In the earlier embodiment, the learned model shared by the control apparatuses is the thermal load model of the air conditioning apparatus. The learned model is not necessarily limited to such and may be selected from any suitable models usable for control of apparatuses to be controlled. In this instance, the operating status may include at least one of the following; type of the apparatus to be controlled; an environment where the apparatus to be controlled is installed, or setting content of the apparatus to be controlled.

3] Model management apparatus 10 may be configured on a cloud server.

4] In the earlier embodiment, the learning algorithm of the thermal load model is a neural network-applied algorithm. Instead, the learning algorithm may be selected from other suitable machine learning algorithms including support vector machines.

5] In the earlier embodiment, the thermal load models having the same entries of input data and output data are used regardless of whether the operating statuses differ. Instead, thermal load models with different entries of input data and output data may optionally be used depending on the operating statuses.

6] The processing steps in the flow chart of FIG. 10 may be routinely carried out each day. Otherwise, the processing steps in the flow chart of FIG. 10 may be decided not to be carried out on any day when the air conditioning apparatus is unused and scheduling of the operation of this apparatus is thus unnecessary.

The embodiments disclosed herein are given by way of example in all aspects and should not be construed as limiting the scope of this disclosure. The scope of this disclosure is solely defined by the appended claims and is intended to cover the claims, equivalents, and all of possible modifications made without departing the scope of this disclosure.

1. A model sharing system, comprising:
a plurality of control apparatuses to each control a corresponding one of apparatuses to be controlled; and
a model management apparatus to store a model already learned correspondingly to an operating status of each of the apparatuses to be controlled,
the control apparatuses each obtaining, from the model management apparatus, the model already learned corresponding to an operating status identical to or similar to the operating status of a corresponding one of the apparatuses to be controlled, the control apparatuses each further controlling the corresponding one of the apparatuses to be controlled using the model already learned,
the operating status comprising at least one of the following: type of the apparatus to be controlled; an environment where the apparatus to be controlled is installed; or setting content of the apparatus to be controlled.

2. The model sharing system according to claim 1, wherein
the apparatuses to be controlled are each an air conditioning apparatus,
the model is a thermal load model of the air conditioning apparatus,
input data of the thermal load model is data that indicate a factor affecting a thermal load of the air conditioning apparatus, and
output data of the thermal load model is data that indicate the thermal load of the air conditioning apparatus.

3. The model sharing system according to claim 2, wherein
the input data comprises at least one of the following: a difference between a set temperature and an outdoor temperature; a difference between a set temperature and an indoor temperature; or a frequency of a compressor provided in the air conditioning apparatus.

4. The model sharing system according to claim 2, wherein
the output data is a length of time for an indoor temperature to reach a set temperature after an indoor unit of the air conditioning apparatus starts to operate.

5. The model sharing system according to claim 2, wherein
the operating status comprises, as the type of the air conditioning apparatus, at least one of the following: number of outdoor units of the air conditioning apparatus; number of indoor units of the air conditioning apparatus; or serial number of the air conditioning apparatus.

6. The model sharing system according to claim 2, wherein
the operating status comprises, as the environment where the air conditioning apparatus is installed, at least one of the following: a spot where the air conditioning apparatus is located; or dimensions of a room where the air conditioning apparatus is located.

7. The model sharing system according to claim 2, wherein
the operating status comprises, as the setting content of the air conditioning apparatus, an indoor temperature variation over a certain period of time while the air conditioning apparatus is being operated.

8. The model sharing system according to claim 2, wherein
the control apparatus issues a request for transmission of the thermal load model designating the operating status of the air conditioning apparatus and obtains a thermal load model already learned transmitted from the model management apparatus in response to the request for transmission, and
the thermal load model already learned corresponds to an operating status identical to or having a highest degree of similarity to the operating status designated earlier.

9. The model sharing system according to claim 2, wherein the control apparatus obtains, by operating the corresponding one of the air conditioning apparatuses, teaching data and input data of the thermal load model for additional learning and carries out additional learning of the thermal load model using the input data and the teaching data thus obtained.

10. The model sharing system according to claim 9, wherein
the control apparatus transmits, to the model management apparatus, the thermal load model already additionally learned and the operating status of the air conditioning apparatus, and
the model management apparatus stores the thermal load model already additionally learned correspondingly to the received operating status.

11. The model sharing system according to claim 2, wherein
the thermal load model is configured as a neural network.

12. A model management apparatus for a model sharing system that allows control apparatuses for a plurality of air conditioning apparatuses to share a plurality of thermal load models already learned, the model management apparatus comprising:
a model storage unit to store therein the thermal load models already learned correspondingly to operating statuses of the air conditioning apparatuses;
a communicator allowed to communicate with the control apparatuses for the air conditioning apparatuses;
a model provider to provide the control apparatus for the air conditioning apparatus with, of the plurality of thermal load model already learned stored in the model storage memory, a thermal load model corresponding to an operating status identical to or having a highest degree of similarity to the operating status of the air conditioning apparatus in response to a request for transmission of the thermal load model designating the operating status of the air conditioning apparatus from the control apparatus for the air conditioning apparatus; and
a model registering memory to obtain the thermal load model already learned designating the operating status of the air conditioning apparatus from the air conditioning apparatus and to prompt the model storage memory to store therein the thermal load model already learned correspondingly to the operating status of the air conditioning apparatus.

13. A control apparatus for an air conditioning apparatus, comprising a communication communicator allowed to communicate with a model management apparatus in charge of managing a thermal load model already learned sharable by control apparatuses for a plurality of air conditioning apparatuses, the model management apparatus being allowed to store the thermal load model already learned correspondingly to an operating status of the air conditioning apparatus,
the control apparatus for the air conditioning apparatus further comprising a controller to issue a request for transmission of the thermal load model designating the operating status of the air conditioning apparatus and to obtain the thermal load model already learned transmitted from the model management apparatus correspondingly to the request for transmission, the thermal load model already learned corresponding to an operating status identical to or having a highest degree of similarity to the operating status designated,
the control apparatus for the air conditioning apparatus further comprising a learner to obtain teaching data and input data of the thermal load model for additional learning and to additionally learn the thermal load model using the teaching data and the input data thus obtained,
the controller controlling the air conditioning apparatus using the thermal load model already additionally learned,
the communicator transmitting, to the model management apparatus, the thermal load model already additionally learned and the operating status of the air conditioning apparatus,
the operating status comprising at least one of the following: type of the air conditioning apparatus; an environment where the air conditioning apparatus is installed; or setting content of the air conditioning apparatus.
